(19) United States
(12) Patent Application Publication
(10) Pub. No.: US 2024/0141513 A1
(43) Pub. Date: May 2, 2024

(54) POROUS TRANSPORT LAYER WITH HIGH CHEMICAL DURABILITY AND A METHOD FOR PREPARING THE SAME

(71) Applicants: HYUNDAI MOTOR COMPANY, SEOUL (KR); KIA CORPORATION, SEOUL (KR); KOREA ADVANCED INSTITUTE OF SCIENCE AND TECHNOLOGY, DAEJEON (KR)

(72) Inventors: Young June Park, Yangpyeong-gun (KR); Woo Chul Jung, Daejeon (KR); Seong Woo Nam, Daejeon (KR); Sang Woo Kim, Daejeon (KR)

(73) Assignees: HYUNDAI MOTOR COMPANY, SEOUL (KR); KIA CORPORATION, SEOUL (KR); KOREA ADVANCED INSTITUTE OF SCIENCE AND TECHNOLOGY, DAEJEON (KR)

(21) Appl. No.: 18/112,848

(22) Filed: Feb. 22, 2023

(30) Foreign Application Priority Data
Oct. 31, 2022 (KR) 10-2022-0142987

(51) Int. Cl. C25B 9/23; C25B 1/04; C25B 13/05; H01M 8/0232; H01M 8/0245; H01M 8/1004

(52) U.S. Cl. CPC C25B 9/23; C25B 1/04; C25B 13/05; H01M 8/0232; H01M 8/0245; H01M 8/1004

(57) ABSTRACT

A porous transport layer is disclosed. The porous transport layer includes a base layer containing a titanium family element, a first coating layer disposed on one surface of the base layer and containing iridium (Ir), and a second coating layer disposed on the other surface of the base layer, and containing at least one of platinum (Pt), gold (Au), and silver (Ag), and a method for preparing the same.

### CROSS-REFERENCE TO RELATED APPLICATION

This application claims the benefit of and priority to Korean Patent Application No. 10-2022-0142987, filed in the Korean Intellectual Property Office on Oct. 31, 2022, the entire contents of which are incorporated herein by reference.

### FIELD

The present disclosure relates to a porous transport layer having high chemical durability and excellent adhesion to a membrane-electrode assembly, a water electrolysis cell or a fuel cell including the same, and a method for preparing the same.

### BACKGROUND

A polymer electrolyte membrane (PEM) water electrolysis system is an electro-chemical conversion device that decomposes water (H₂O) into hydrogen (H₂) and oxygen (O₂) using electricity. The PEM water electrolysis system may be operated at a high current density, may produce high-purity hydrogen and oxygen because a gas permeability via a solid electrolyte membrane is low, and may have high stability. Such PEM water electrolysis system is composed of a PEM water electrolysis stack and a peripheral device for driving the same, and the PEM water electrolysis stack is composed of a plurality of PEM water electrolysis cells.

### SUMMARY

The present disclosure has been made to solve the above-mentioned problems occurring in the prior art while advantages achieved by the prior art are maintained intact.

An aspect of the present disclosure provides a porous transport layer that enables process simplification as a noble metal coating layer may be formed on a surface thereof without additional process steps or equipment and has high chemical durability, a water electrolysis cell or a fuel cell including the same, and a method for preparing the same.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a porous transport layer is provided. The porous transport layer includes a base layer containing a titanium family element, a first coating layer disposed on one surface of the base layer and containing iridium (Ir), and a second coating layer disposed on the other surface of the base layer, and containing at least one of platinum (Pt), gold (Au), and silver (Ag).

According to another aspect of the present disclosure, a water electrolysis cell or a fuel cell including the porous transport layer is provided.

According to another aspect of the present disclosure, a method is provided for preparing a porous transport layer. The method includes stacking a first coating layer containing iridium (Ir) on one surface of a base layer containing a titanium family element. The method further includes stacking a second coating layer containing at least one of platinum (Pt), gold (Au), and silver (Ag) on the other surface of the base layer.

### BRIEF DESCRIPTION OF THE DRAWINGS

The above and other objects, features, and advantages of the present disclosure are apparent from the following detailed description taken in conjunction with the accompanying drawings:

FIG. 1 is a cross-sectional view of a typical polymer electrolyte membrane (PEM) water electrolysis cell;

FIG. 2 is cross-sectional views of a porous transport layer according to an embodiment of the present disclosure;

FIG. 3 is cross-sectional views of a porous transport layer according to an embodiment of the present disclosure;

FIG. 4 is cross-sectional views of a porous transport layer according to an embodiment of the present disclosure;

FIG. 5 is a cross-sectional view of a water electrolysis cell according to an embodiment of the present disclosure; and

FIG. 6 shows cross-sectional SEM and EDAX mapping results of a porous transport layer according to an embodiment of the present disclosure.

### DETAILED DESCRIPTION

Herein, when a certain portion “includes” a certain component, this means that the certain portion may further include other components without excluding said other components unless otherwise stated.

Herein, when a first member is located on a “surface”, “one surface”, “the other surface” or “both surfaces” of a second member, this includes not only a case in which the first member is in contact with the second member, but also a case in which a third member exists between the two members.

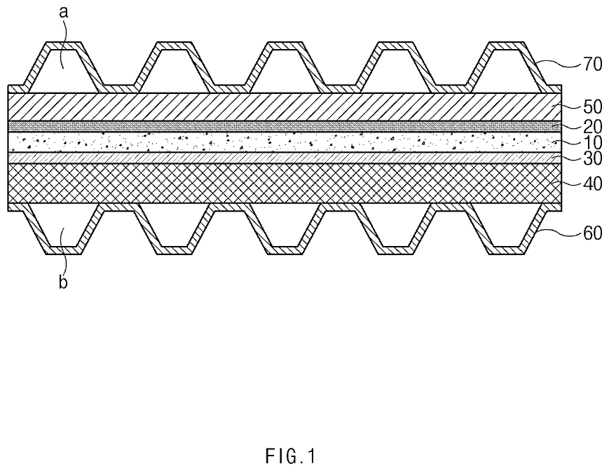

Referring to FIG. 1, a PEM water electrolysis cell may include a membrane-electrode assembly (MEA) including an electrolyte membrane 10, an anode electrode 20, and a cathode electrode 30, a gas diffusion layer (GDL) 40 for the cathode, a porous transport layer (PTL) 50 for the anode, a cathode bipolar plate 60, and an anode bipolar plate 70. In this regard, water introduced via an anode bipolar plate flow path ‘a’ is supplied and diffused to the anode electrode 20 via the PTL 50 and caused to be in contact with the MEA so as to discharge oxygen gas O₂ generated from the MEA. Hydrogen gas generated at the cathode electrode 30 is discharged via the GDL 40 and a cathode bipolar plate flow path ‘b’. In an electrochemical reaction of such PEM water electrolysis cell, after the water supplied to the anode is separated into hydrogen ions (H⁺) and electrons together with the oxygen gas O₂ by an oxygen evolution reaction (OER), the hydrogen ions (H⁺) and the electrons move to the cathode via the electrolyte membrane and an external circuit, respectively, and generate hydrogen gas H₂ by a hydrogen evolution reaction.

The PTL uniformly distributes and/or diffuses the water as a reactant onto a surface of the anode electrode, discharges the oxygen generated at the anode electrode to the outside via the bipolar plate, and collects and/or transports the electrons generated by the electrochemical reaction. To maximize such functions of the PTL, various physical properties such as corrosion resistance, electrical conductivity, distributivity and diffusivity, permeability, low surface roughness, mechanical strength, or the like are needed.

In this regard, for the PTL, materials with excellent electrical conductivity, thermal conductivity, and corrosion resistance and low Ohmic losses and mass transport losses are desirable. Accordingly, a conventional PTL may be made of titanium (Ti) having excellent physical and chemical properties because corrosion does not occur even under high potential and acidic conditions. However, the titanium may easily be contaminated and oxidized by an atmospheric environment because of a nature of the material. Therefore, in the titanium-based PTL, after a molding and sintering process, there is a problem in that a performance and a durability of a water electrolysis stack are lowered as an electrical resistance is increased because TiOₓ is generated on a surface of the PTL.

As an alternative to such problem, a method for coating a noble metal material (such as platinum, iridium, gold, silver, or the like) as a protective layer of the titanium-based PTL in an electrolytic plating scheme after the molding and sintering process has been proposed. For example, Japanese Patent Application Publication No. 1998-102273 (Patent Document 1) discloses a water electrolysis cell having a power supply body in which platinum plating is applied to a surface of a metal sintered body. Specifically, in the method for plating the noble metal such as the platinum on the surface of the metal sintered body (PTL) as in Patent Document 1, a separate process of plating the noble metal may be performed after the PTL molding and sintering process. However, such separate plating process requires equipment for the plating, and the PTL is fixed to a cradle for the coating, which causes a problem that a noble metal coating layer is not plated on a fixed portion of the PTL. In addition, because the separate plating process is performed after the sintering process, there was a limit that the separate plating process should be performed as a sheet-to-sheet process in consideration of rigidity of the PTL.

Therefore, there is a need for research and development on a porous transport layer that enables process simplification as the noble metal coating layer may be formed on the surface thereof without additional process steps or equipment, and has excellent chemical durability, a water electrolysis cell or a fuel cell including the same, and a method for preparing the same.

Accordingly, the present disclosure provides a porous transport layer that enables the process simplification as the noble metal coating layer may be formed on the surface thereof without the additional process steps or equipment, and has excellent electrical conductivity and durability, a water electrolysis cell or a fuel cell including the same, and a method for preparing the same.

### Porous Transport Layer

The porous transport layer according to the present disclosure includes a base layer containing a titanium family element, a first coating layer disposed on one surface of the base layer and containing the iridium (Ir), and a second coating layer disposed on the other surface of the base layer and containing platinum (Pt), gold (Au), silver (Ag), or combinations thereof.

In one example, the porous transport layer according to the present disclosure includes the first coating layer containing the iridium and the second coating layer containing a noble metal element other than the iridium, thereby having excellent economic feasibility as a preparation cost may be reduced while preventing deterioration of a performance of the PTL and maintaining safety. In particular, the first coating layer contains particles of the iridium to have an effect of maximizing a performance of the membrane-electrode assembly (MEA) using the Ir as the anode electrode while preventing the deterioration of the performance of the PTL and maintaining the safety. In addition, the second coating layer contains the noble metal element other than iridium and cheaper than the iridium to reduce the preparation cost, thereby improving the economic feasibility of the product.

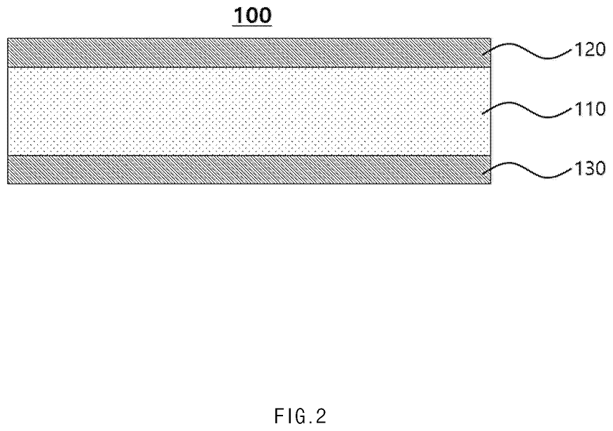

Referring to FIG. 2, a porous transport layer 100 according to the present disclosure according to the present disclosure may include a base layer 110, a first coating layer 120 disposed on one surface of the base layer 110, and a second coating layer 130 disposed on the other surface of the base layer 110.

### Base Layer

The base layer serves to uniformly distribute and/or diffuse the water as the reactant onto the surface of the anode, and discharge the oxygen generated at the anode to the outside via the bipolar plate.

The titanium family element may include titanium, zirconium, hafnium, or combinations thereof. In one example, the titanium family element may include titanium.

In addition, particles of the titanium family element in the base layer may be used without any particular limitation as long as it is in a form that may be used in preparing the PTL, and, for example, may be in a particle form, a mesh form, or a fiber form. In this regard, the particle form may include a circular form, an oval form, or an amorphous form.

The particles of the titanium family element may have an average size in a range from 20 to 80 μm, from 25 to 45 μm, or from 30 to 50 μm. When the average size of the particles of the titanium family element is lower than the above range, a porosity of the prepared base layer may be too low, and rigidity thereof may be low. When the average size of the particles exceeds the above range, the porosity of the prepared base layer may be too high and roughness thereof may be high, so that a problem of low performance of the porous transport layer may occur because of high resistance. In this regard, an average particle diameter of the particles may be a particle diameter of cumulative distribution 50% (D₅₀) in a particle diameter distribution measured using a particle size analyzer (PSA).

The base layer may have an average thickness in a range from 20 to 1,000 μm, from 300 to 800 μm, or from 200 to 300 μm. When the average thickness of the base layer is lower than the above range, uniform surface pressure may not be formed in the stack as the rigidity of the porous transport layer is too low, or uniform diffusion may not be achieved because of the too small thickness and a performance thereof may be reduced. When the average thickness of the base layer exceeds the above range, a mass transfer resistance may be too high, so that the performance of the porous transport layer may be reduced in a high current section.

### First Coating Layer

The first coating layer is oxidized instead of the titanium family element in the base layer so as to increase the electrical resistance of the PTL, thereby preventing the problem of reducing the performance and the durability of the water electrolysis stack.

The first coating layer contains the iridium (Ir). In this regard, the iridium in the first coating layer may be used without any particular limitation as long as it is in a form that may be used in preparing the PTL, and, for example, may be in the circular form, the oval form, or the amorphous form.

In addition, particles of the iridium in the first coating layer may have an average size in a range from 0.1 to 10 μm, from 0.1 to 2 μm, or from 0.1 to 1 μm. When the average size of the particles of the iridium is lower than the above range, the first coating layer may have to be coated for a long time and the first coating layer may not be coated with a uniform thickness in the coating process. In addition, when the average size of the particles of the iridium exceeds the above range, the particles of the iridium may not be coated over an entire surface area, and a portion of the titanium family element in the base layer may be exposed to the surface. In this regard, an average particle diameter of the particles may be the particle diameter of the cumulative distribution 50% (D 50) in the particle diameter distribution measured using the particle size analyzer (PSA).

In addition, the first coating layer may have an average thickness in a range from 1 to 10 μm, from 1 to 8 μm, or from 1 to 4 μm. When the average thickness of the first coating layer is lower than the above range, a titanium oxide layer (TiOₓ) may be generated over time. When the corresponding oxide layer grows (thickens) over time, and a thickness thereof becomes equal to or greater than a specific thickness, a contact resistance of the PTL may increase rapidly. When the thickness of the corresponding oxide layer further increases, the coating layer may be covered by the oxide layer, or the coating layer may be peeled off. When the average thickness of the first coating layer exceeds the above range, an obtained effect may be small compared to the thickness of the coating layer, and the cost may become excessively high, so that the economic feasibility may be deteriorated.

In addition, the first coating layer may contain the particles of the iridium of an applied amount equal to or greater than 0.1 mg/cm², in a range from 0.1 to 5.0 mg/cm², or in a range from 0.5 to 3.0 mg/cm². When the applied amount of the iridium particles in the first coating layer is lower than the above range, as the titanium family element in the base layer is exposed to the atmosphere, the PTL is oxidized, which may deteriorate the performance.

### Second Coating Layer

The second coating layer is oxidized instead of the titanium family element in the base layer so as to increase the electrical resistance of the PTL, thereby preventing the problem of reducing the performance and the durability of the water electrolysis stack.

The second coating layer contains the noble metal element, which is platinum (Pt), the gold (Au), the silver (Ag), or combinations thereof, other than the iridium.

In addition, the noble metal element other than the iridium in the second coating layer may be used without any particular limitation as long as it is in a form that may be used in preparing the PTL, and, for example, may be in the circular form, the oval form, or the amorphous form.

Particles of the noble metal element other than the iridium may have an average size in a range from 0.1 to 10 μm, from 0.1 to 2 μm, or from 0.1 to 1 μm. When the average size of the particles of the noble metal element other than the iridium is lower than the above range, the second coating layer may have to be coated for a long time and the second coating layer may not be coated with a uniform thickness in the coating process. In addition, when the average size of the particles of the noble metal element other than the iridium exceeds the above range, the particles of the noble metal element may not be coated over an entire surface area, and a portion of the titanium family element in the base layer may be exposed to the surface. In this regard, an average particle diameter of the particles may be the particle diameter of the cumulative distribution 50% (D₅₀) in the particle diameter distribution measured using the particle size analyzer (PSA).

The second coating layer may further contain ruthenium (Ru), palladium (Pd), rhodium (Rh), osmium (Os), or combinations thereof. In this regard, a form and an average particle size of particles of the additional element are the same as described in the form and the average particle size of the noble metal element.

In addition, the second coating layer may have an average thickness in a range from 1 to 10 μm, from 1 to 8 μm, or from 1 to 4 μm. When the average thickness of the second coating layer is lower than the above range, a titanium oxide layer (TiOₓ) may be generated over time. When the corresponding oxide layer grows (thickens) over time, and a thickness thereof becomes equal to or greater than a specific thickness, the contact resistance of the PTL may increase rapidly. When the thickness of the corresponding oxide layer further increases, the coating layer may be covered by the oxide layer, or the coating layer may be peeled off. When the average thickness of the second coating layer exceeds the above range, an obtained effect may be small compared to the thickness of the coating layer, and the cost may become excessively high, so that the economic feasibility may be deteriorated.

The porous transport layer may further include an antioxidant layer disposed on the first coating layer and containing a lanthanide element.

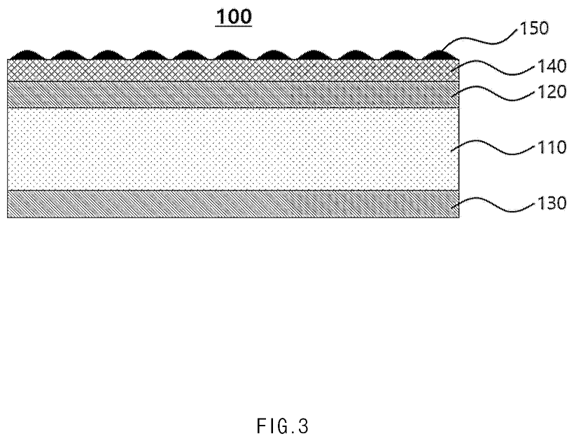

Referring to FIG. 3, the porous transport layer 100 according to the present disclosure may include the base layer 110, the first coating layer 120 disposed on one surface of the base layer 110, the second coating layer 130 disposed on the other surface of the base layer 110, and an antioxidant layer 140 disposed on the first coating layer 120.

### Antioxidant Layer

The antioxidant layer prevents a membrane damage by hydroxyl radicals (·OH) and acts as a water trap to prevent drying of the membrane even in a non-humidifying system with hydrophilicity thereof.

The lanthanide element may include cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu). In one example, the lanthanide element may include cerium (Ce).

Particles of the lanthanide element may be in a form of the lanthanide element, an oxide of the lanthanide element, a composite of the lanthanide element, or the like. In one example, the particles of the lanthanide element may be cerium particles, cerium ions, a cerium oxide, or a cerium composite. In this regard, the cerium composite may include a cerium-zirconium composite, a composite of the cerium oxide and a zirconium oxide, or the like.

In one example, the antioxidant layer may contain the cerium oxide (CeO₂). When the antioxidant layer contains the cerium oxide (CeO₂), as the cerium ions continuously act, the antioxidant layer may effectively prevent the membrane damage and serve as the water trap as described above.

The antioxidant layer may have an average thickness in a range from 5 to 100 μm, from 5 to 20 μm, or from 5 to 10 μm. When the average thickness of the antioxidant layer is within the above range, deterioration of durability of the fuel cell or the water electrolysis cell caused by deterioration of the electrolyte membrane in the MEA may be prevented.

The porous transport layer according to the present disclosure may further include a bonding layer disposed on the antioxidant layer and containing an ionomer.

### Bonding Layer

The bonding layer serves to improve a bonding force between the porous transport layer and the membrane-electrode assembly.

In addition, the bonding layer may contain the ionomer. The ionomer serves to increase an effective reaction area of a catalyst by increasing a three-phase boundary area via contact with the electrode in the membrane-electrode assembly and to facilitate a movement of the hydrogen ions.

The ionomer may be a hydrogen ion conductive polymer, e.g., a perfluorosulfonate ionomer. Commercially available products of the hydrogen ion conductive polymer may include, for example, DuPont's Nafion, Asahi Glass's Flemion, Asahi Chemical's Asiplex, Dow Chemical's Dow XUS, or the like, but the present disclosure may not be limited thereto.

In addition, the bonding layer may contain the ionomer of an applied amount equal to or greater than 1.0 μg/cm². In one example, the bonding layer may contain the ionomer of an applied amount in a range from 1 to 5 μg/cm² or from 2 to 4 μg/cm². In this regard, a reference area within a unit of the applied amount of the ionomer is based on a surface area 1 cm² of the antioxidant layer. That is, “ionomer of an applied amount equal to or greater than 1.0 μg/cm²” means that the ionomer of an amount equal to or greater than 1.0 μg is contained with respect to 1 cm² of the bonding layer.

When a content of the ionomer in the bonding layer is smaller than 1 μg/cm², a lack of the bonding force between the porous transport layer and the membrane-electrode assembly requires a high bonding pressure and a high bonding temperature. This may cause a problem in that the porous transport layer is damaged, or the electrolyte membrane shrinks and a boundary between the porous transport layer and the membrane-electrode assembly collapses. In addition, when the content of the ionomer in the bonding layer is within the above range, a problem of flooding may be prevented by hygroscopicity of the ionomer and the bonding force between the porous transport layer and the membrane-electrode assembly may be excellent, so that the durability of the fuel cell or the water electrolysis cell may be improved.

In addition, the bonding layer may be disposed on at least a portion of the antioxidant layer. For example, the bonding layer may be formed in a form of a plurality of discontinuous dots on the antioxidant layer. In addition, the bonding layer may be formed as a continuous layer on the antioxidant layer.

Referring to FIG. 3, the porous transport layer 100 according to the present disclosure may include the base layer 110, the first coating layer 120 disposed on one surface of the base layer 110, the second coating layer 130 disposed on the other surface of the base layer 110, the antioxidant layer 140 disposed on the first coating layer 120, and a bonding layer 150 disposed on the antioxidant layer 140 in the form of the plurality of discontinuous dots.

That is, for example, referring to FIG. 3, in the water electrolysis cell or the fuel cell including the porous transport layer, the porous transport layer in a portion where the bonding layer is not disposed may be bonded to the membrane-electrode assembly. When the bonding layer has the form of the plurality of discontinuous dots as described above, permeability of gases (oxygen and/or air) may be improved, so that a performance of the fuel cell or the water electrolysis cell may be improved. In this regard, when the bonding layer has the form of the plurality of discontinuous dots, the bonding layer may exist as a discontinuous layer without being impregnated or recessed into the membrane-electrode assembly or the porous transport layer.

In this regard, each dot constituting the bonding layer may have an average diameter in a range from 1 μm to 10 mm or from 10 μm to 5 mm. When the average diameter of each dot is within the above range, a contact area between the membrane-electrode assembly and the bonding layer may be increased, so that an effect of preventing the deterioration of the electrolyte membrane may be improved.

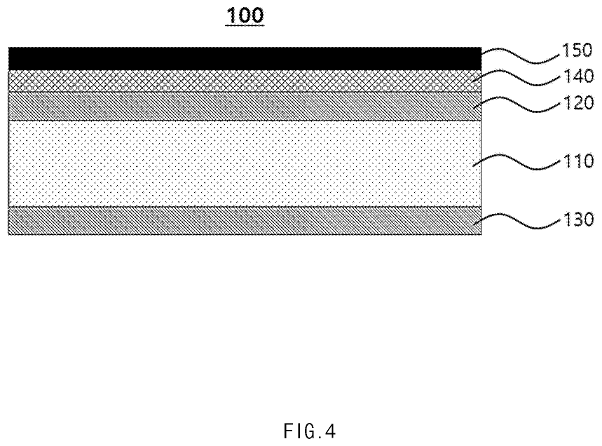

Referring to FIG. 4, the porous transport layer 100 according to the present disclosure may include the base layer 110, the first coating layer 120 disposed on one surface of the base layer 110, the second coating layer 130 disposed on the other surface of the base layer 110, the antioxidant layer 140 disposed on the first coating layer 120, and the bonding layer 150 formed as the continuous layer on the antioxidant layer 140.

In addition, the bonding layer may have an average thickness in a range from 50 nm to 50 μm or from 100 nm to 10 μm. When the average thickness of the bonding layer is within the above range, the deterioration of the durability of the fuel cell or the water electrolysis cell caused by the deterioration of the electrolyte membrane in the MEA may be prevented, and adhesion with the MEA may be improved.

The porous transport layer according to the present disclosure as described above may be oxidized instead of the titanium family element in the base layer and may have the excellent chemical durability, so that the porous transport layer may be suitably used as a material for the water electrolysis cell or the fuel cell.

### Water Electrolysis Cell or Fuel Cell

The water electrolysis cell or the fuel cell of the present disclosure may include the porous transport layer as described above.

For example, the membrane-electrode assembly (MEA) may be disposed on the first coating layer of the porous transport layer, and the anode bipolar plate may be disposed on the second coating layer.

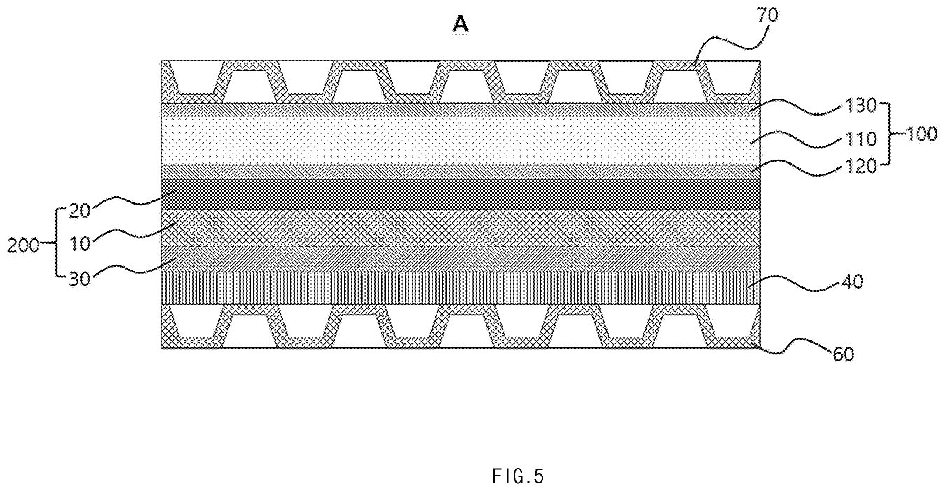

Referring to FIG. 5, a water electrolysis cell ‘A’ according to the present disclosure may have a form in which the anode bipolar plate 70, the porous transport layer (PTL) 100 including the second coating layer 130, the base layer 110, and the first coating layer 120, a membrane-electrode assembly (MEA) 200 including the anode electrode 20, the electrolyte membrane 10, and the cathode electrode 30, the gas diffusion layer (GDL) 40, and the cathode bipolar plate 60 are stacked in order.

### Method for Preparing Porous Transport Layer

A method for preparing the porous transport layer according to the present disclosure may include stacking the first coating layer containing the iridium (Ir) on one surface of the base layer containing the titanium family element and stacking the second coating layer containing at least one of the platinum (Pt), the gold (Au), and the silver (Ag) on the other surface of the base layer.

### Stacking First Coating Layer

In the present operation, the first coating layer containing the iridium (Ir) is stacked on one surface of the base layer containing the titanium family element.

The titanium family element may include titanium, zirconium, hafnium, or combinations thereof. In one example, the titanium family element may include titanium.

In addition, the particles of the titanium family element have the same shape and the same average diameter as described in the porous transport layer.

The base layer may have the average thickness in the range from 20 to 1,000 μm, from 300 to 800 μm, or from 200 to 300 μm.

The iridium in the first coating layer may be used without any particular limitation as long as it is in the form that may be used in preparing the PTL. The shape and the average diameter of the particles of the iridium are the same as those described in the porous transport layer.

In addition, the first coating layer may be formed using a spray coating method, a 3D printing method, an inkjet printing method, a slot die coating method, a bar coating method, a powder scattering coating method, a screen printing method, or a knife coating method. In one example, the first coating layer may be formed in the spray coating method.

In this regard, the first coating layer may be formed by coating a first coating layer slurry containing the iridium (Ir) and a solvent. In this regard, the solvent may be used without any particular limitation as long as it is a solvent that may be used in preparing the PTL, and may be ethanol, toluene, or the like.

In one example, the first coating layer may be formed by being applied in the coating method as described above and then dried. In this regard, the drying may be performed at a temperature in a range from 60 to 90° C. or from 70 to 80° C.

In addition, the first coating layer may have the average thickness in a range from 1 to 10 μm, from 1 to 8 μm, or from 1 to 4 μm.

### Stacking Second Coating Layer

In the present operation, the second coating layer containing the noble metal element, (which is platinum (Pt), gold (Au), silver (Ag), or combinations thereof), other than the iridium is stacked on the other surface of the base layer.

The second coating layer contains platinum (Pt), gold (Au), silver (Ag), or combinations thereof. In addition, the shape and the average diameter of the particles of the noble metal element other than the iridium in the second layer are the same as those described in the porous transport layer.

In addition, the second coating layer may further contain at least one of the ruthenium (Ru), the palladium (Pd), the rhodium (Rh), and the osmium (Os).

The second coating layer may be formed using the spray coating method, the 3D printing method, the inkjet printing method, the slot die coating method, the bar coating method, the powder scattering coating method, the screen printing method, or the knife coating method. In one example, the second coating layer may be formed in the spray coating method.

In this regard, the second coating layer may be formed by coating a second coating layer slurry containing the particles of the noble metal element other than the iridium and a solvent. In this regard, the solvent may be used without any particular limitation as long as it is a solvent that may be used in preparing the PTL, and may be ethanol, toluene, isopropyl alcohol (IPA), n-propyl alcohol (NPA), or the like.

In one example, the second coating layer may be formed by being applied in the coating method as described above and then dried. In this regard, the drying may be performed at the temperature in the range from 60 to 90° C. or from 70 to 80° C.

In addition, the second coating layer may have the average thickness in a range from 1 to 10 μm, from 1 to 8 μm, or from 1 to 4 μm.

The preparation method according to the present disclosure may further include stacking the antioxidant layer containing the lanthanide element on the first coating layer.

### Stacking Antioxidant Layer

The lanthanide element may include cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu). In one example, the lanthanide element may include the cerium (Ce).

The shape and the average diameter of the particles of the lanthanide element are the same as those described in the porous transport layer.

The antioxidant layer may be formed using the spray coating method, the 3D printing method, the inkjet printing method, the slot die coating method, the bar coating method, the powder scattering coating method, the screen printing method, or the knife coating method. In one example, the antioxidant layer may be formed in the spray coating method.

In this regard, the antioxidant layer may be formed by coating an antioxidant layer slurry containing the particles of the lanthanide element and a solvent. In this regard, the solvent may be used without any particular limitation as long as it is a solvent that may be used in preparing the PTL, and may be water, ethanol, toluene, IPA, NPA, or the like.

In one example, in the preparation method, the first coating layer slurry may be applied in the coating method as described above, and the antioxidant layer slurry may be applied in the coating method as described above and then dried. In this regard, the drying may be performed at the temperature in the range from 60 to 90° C. or from 70 to 80° C.

The preparation method according to the present disclosure may further include stacking the bonding layer containing the ionomer on the antioxidant layer.

### Stacking Bonding Layer

The specific example, the applied amount, or the like of the ionomer are the same as those described in the porous transport layer.

The bonding layer may be formed using the spray coating method, the 3D printing method, the inkjet printing method, the slot die coating method, the bar coating method, the powder scattering coating method, the screen printing method, or the knife coating method. In one example, the bonding layer may be formed in the spray coating method.

In this regard, the bonding layer may be formed by coating a bonding layer slurry containing the ionomer and a solvent. In this regard, the solvent may be used without any particular limitation as long as it is a solvent that may be used in preparing the PTL, and may be water, ethanol, toluene, IPA, NPA, or the like.

In one example, in the preparation method, the first coating layer slurry may be applied in the coating method as described above, the antioxidant layer slurry may be applied in the coating method as described above, and the bonding layer slurry may be applied in the coating method as described above and then dried. In this regard, the drying may be performed at the temperature in the range from 60 to 90° C. or from 70 to 80° C.

The preparation method according to the present disclosure as described above may enable the process simplification as the coating layer may be formed on a surface without the additional process steps or equipment and may enable application of a roll-to-roll scheme by disposing the noble metal coating layer before the sintering process of the PTL.

Hereinafter, the present disclosure is described in more detail with Examples. However, such Examples are only for helping the understanding of the present disclosure, and the scope of the present disclosure is not limited to such Examples in any sense.

### EXAMPLES

### Example 1. Preparation of Porous Transport Layer

The base layer with the average thickness of 300 μm was prepared using the titanium with the average particle size of 32 μm in the tape casting process. Thereafter, the first coating layer having the average thickness of 4 μm was prepared by applying the iridium (Ir) on one surface of the base layer in the spray coating method. Thereafter, the second coating layer having the average thickness of 4 μm was prepared by applying the platinum (Pt) on the other surface of the base layer in the spray coating method, so that a porous transport layer-1 was prepared.

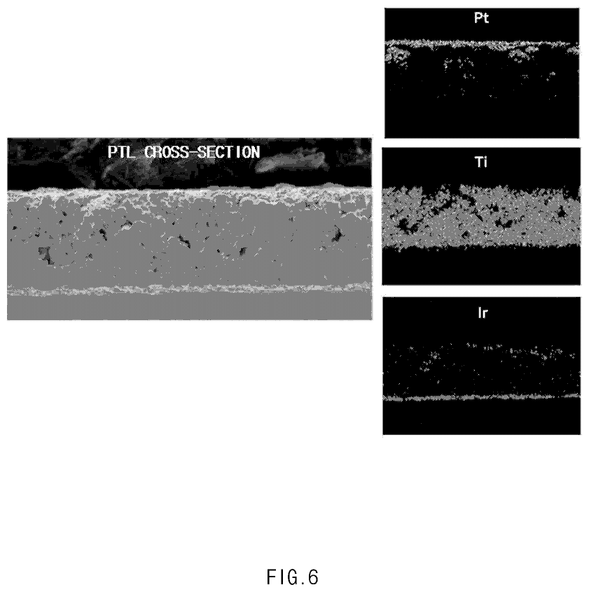

Cross-sectional SEM and EDAX mapping results of the prepared porous transport layer-1 are shown in FIG. 6. As shown in FIG. 6, it may be identified that the Ir coating layer (the first coating layer) was disposed on one surface of the base layer, and the Pt coating layer (the second coating layer) was disposed on the other surface of the base layer. In addition, because the base layer is a porous body, some of the coated components permeated into the base layer.

### Examples 2 to 5 and Comparative Examples 1 to 4

Porous transport layers were prepared in the same manner as in Example 1, except that a composition and a thickness of each layer were adjusted as shown in Table 1 below.

TABLE 1

| | First coating layer | | Base layer | | Second coating layer | |
|---|---|---|---|---|---|---|
| | | Thickness | | Thickness | | Thickness |
| | Component | (μm) | Component | (μm) | Component | (μm) |
| Example 1 | Iridium (Ir) | 4 | Titanium (Ti) | 300 | platinum (Pt) | 4 |
| Example 2 | Iridium (Ir) | 4 | Titanium (Ti) | 300 | platinum (Pt) | 1 |
| Example 3 | Iridium (Ir) | 4 | Titanium (Ti) | 300 | platinum (Pt) | 10 |
| Example 4 | Iridium (Ir) | 1 | Titanium (Ti) | 300 | platinum (Pt) | 4 |
| Example 5 | Iridium (Ir) | 10 | Titanium (Ti) | 300 | platinum (Pt) | 4 |
| Comparative | Iridium (Ir) | 0.1 | Titanium (Ti) | 300 | platinum (Pt) | 4 |
| Example 1 | | | | | | |
| Comparative | Iridium (Ir) | 15 | Titanium (Ti) | 300 | platinum (Pt) | 4 |
| Example 2 | | | | | | |
| Comparative | Iridium (Ir) | 4 | Titanium (Ti) | 300 | platinum (Pt) | 0.1 |
| Example 3 | | | | | | |
| Comparative | Iridium (Ir) | 4 | Titanium (Ti) | 300 | platinum (Pt) | 15 |
| Example 4 | | | | | | |

### Experimental Example 1. Performance Evaluation

Performance evaluation was performed in a following manner for the porous transport layers of Examples 1 to 5 and Comparative Examples 1 to 4, and results are shown in Table 2 below.

In one example, performance evaluation of the water electrolysis system stack was performed by fastening the porous transport layer of 17 cm×22 cm (horizontal×vertical) to the water electrolysis system stack and then adding water thereto with a flow rate of 0.2 LPM at 80° C. to perform IV performance evaluation, a current density at a voltage of 2.0 V was obtained, and the performance evaluation result and the current density were compared with each other.

In addition, durability evaluation of the corresponding water electrolysis system stack was performed by initially measuring a voltage required to obtain a current density of 2.50 A/cm², then performing electrostatic potential evaluation at 2.0 V for 1,000 hours, then calculating the voltage required to obtain the current density of 2.50 A/cm² again, and then calculating an increase in an amount of voltage required for each hour. As the voltage required to obtain the same current density increases, a system performance deteriorates. Therefore, it may be determined that the durability is low as the voltage requirement for each hour increases. For example, in Example 1 of Table 2 below, 0.515 μV/hr increased for the 1,000 hours, which means that an additional voltage of 0.515 V is needed after the 1,000 hours to obtain the same current density. In Comparative Example 1, 1.175 μV/hr increased for the 1,000 hours, which means that an additional voltage of 1.175 V is needed.

TABLE 2

| | | Performance |
|---|---|---|
| | Current density | deterioration rate |
| Division | (@ 2.0 V) [A/cm²] | (@2.5 A/cm²) [+μV/hr] |
| Example 1 | 3.25 | 0.515 |
| Example 2 | 3.02 | 0.617 |
| Example 3 | 3.47 | 0.378 |
| Example 4 | 2.97 | 0.592 |
| Example 5 | 3.45 | 0.384 |
| Comparative | 1.47 | 1.275 |
| Example 1 | | |
| Comparative | 3.68 | 0.239 |
| Example 2 | | |
| Comparative | 1.52 | 1.151 |
| Example 3 | | |
| Comparative | 3.56 | 0.238 |
| Example 4 | | |

As shown in Table 2, as a result of the performance evaluation, Comparative Examples 1 and 3 with the thin first coating layer or the thin second coating layer had low current densities and high performance deterioration rates, thereby having very poor durability.

In addition, Comparative Examples 2 and 4 with the thick first coating layer or the thick second coating layer had high current densities and low performance deterioration rates, so that stack performances thereof were improved, but an increase in the performance compared to an increased thickness was not great, which causes the deterioration of the economic feasibility.

The porous transport layer according to the present disclosure may be oxidized instead of the titanium family element in the base layer and may have the excellent chemical durability, so that the porous transport layer may be suitably used as the material for the water electrolysis cell or the fuel cell.

In addition, the preparation method according to the present disclosure may enable the process simplification as the coating layer may be formed on the surface without the additional process steps or equipment and may enable the application of the roll-to-roll scheme by disposing the noble metal coating layer before the sintering process of the porous transport layer (PTL) for the anode.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A porous transport layer comprising:
a base layer comprising a titanium family element;
a first coating layer disposed on a first surface of the base layer, wherein the first coating layer comprises iridium (Ir); and
a second coating layer disposed on a second, opposite surface of the base layer, wherein the second coating layer comprises platinum (Pt), gold (Au), silver (Ag), or combinations thereof.

2. The porous transport layer of claim 1, wherein the titanium family element comprises titanium, zirconium, hafnium, or combinations thereof.

3. The porous transport layer of claim 1, wherein the second coating layer further comprises ruthenium (Ru), palladium (Pd), rhodium (Rh), osmium (Os), or combinations thereof.

4. The porous transport layer of claim 1, wherein the first coating layer has an average thickness in a range from 1 to 10 micrometers (μm),
wherein the base layer has an average thickness in a range from 20 to 1,000 μm, and
wherein the second coating layer has an average thickness in a range from 1 to 10 μm.

5. The porous transport layer of claim 1, further comprising:
an antioxidant layer disposed on the first coating layer such that the first coating layer is positioned between the antioxidant layer and the base layer,
wherein the antioxidant layer comprises a lanthanide element.

6. The porous transport layer of claim 5, wherein the antioxidant layer has an average thickness in a range from 5 to 100 μm.

7. The porous transport layer of claim 5, further comprising:
a bonding layer disposed on the antioxidant layer such that the antioxidant layer is positioned between the bonding layer and the first coating layer,
wherein the bonding layer comprises an ionomer.

8. The porous transport layer of claim 7, wherein the bonding layer contains the ionomer of an applied amount equal to or greater than 1 μg/cm².

9. The porous transport layer of claim 7, wherein the bonding layer is in a form of a plurality of discontinuous dots on the antioxidant layer.

10. The porous transport layer of claim 7, wherein the bonding layer is a continuous layer on the antioxidant layer.

11. A water electrolysis cell or a fuel cell comprising:
a porous transport layer comprising:
a base layer comprising a titanium family element;
a first coating layer disposed on a first surface of the base layer, wherein the first coating layer comprises iridium (Ir); and
a second coating layer disposed on a second, opposite surface of the base layer, wherein the second coating layer comprises platinum (Pt), gold (Au), silver (Ag), or combinations thereof.

12. The water electrolysis cell or the fuel cell of claim 11, further comprising:
an anode bipolar plate disposed on the second coating layer of the porous transport layer; and
a membrane-electrode assembly (MEA) disposed on the first coating layer.

13. A method for preparing a porous transport layer, the method comprising:
stacking a first coating layer containing iridium (Ir) on a first surface of a base layer, wherein the first coating layer comprises a titanium family element; and
stacking a second coating layer on a second, opposite surface of the base layer, wherein the second coating layer comprises platinum (Pt), gold (Au), silver (Ag), or combinations thereof.

14. The method of claim 13, wherein the titanium family element comprises titanium, zirconium, hafnium, or combinations thereof.

15. The method of claim 13, wherein the second coating layer further comprises ruthenium (Ru), palladium (Pd), rhodium (Rh), osmium (Os), or combinations thereof.

16. The method of claim 13, wherein each of the first coating layer and the second coating layer is independently formed using a spray coating method, a 3D printing method, an inkjet printing method, a slot die coating method, a bar coating method, a powder scattering coating method, a screen printing method, or a knife coating method.

17. The method of claim 13, further comprising:
stacking an antioxidant layer on the first coating layer such that the first coating layer is positioned between the antioxidant layer and the base layer,
wherein the antioxidant layer comprises a lanthanide element.

18. The method of claim 17, further comprising:
stacking a bonding layer on the antioxidant layer such that the antioxidant layer is positioned between the bonding layer and the first coating layer,
wherein the bonding layer comprises a hydrogen ion conductive polymer.
